(19) United States
(12) Patent Application Publication
(10) Pub. No.: US 2013/0024117 A1
(43) Pub. Date: Jan. 24, 2013

(54) User Navigation Guidance and Network System

(71) Applicants: SCOTT R. PAVETTI, SPRINGDALE, PA (US); MARK E. ROBERTS, PITTSBURGH, PA (US); VIKTOR GÖTZ, WEXFORD, PA (US)

(72) Inventors: SCOTT R. PAVETTI, SPRINGDALE, PA (US); MARK E. ROBERTS, PITTSBURGH, PA (US); VIKTOR GÖTZ, WEXFORD, PA (US)

(21) Appl. No.: 13/325,623

(22) Filed: Dec. 14, 2011

Related U.S. Application Data
(60) Provisional application No. 61/508,828, filed on Jul. 18, 2011.

(51) Int. Cl. G01C 21/00

(52) U.S. Cl. 701/538

(57) ABSTRACT

A user navigation guidance system, including: at least one personal inertial navigation module associated with at least one user and configured to generate navigation data; at least one central controller configured to: directly or indirectly receive at least a portion of the navigation data; and generate global scene data in a global reference frame for locating users, features, and/or positions; at least one navigation guidance unit configured to: directly or indirectly receive at least a portion of the global scene data from the at least one central controller; and generate guidance data; and at least one display device configured to generate and provide visual information to the at least one user. A user navigation network system is also disclosed.

### CROSS REFERENCE TO RELATED APPLICATIONS

This application claims benefit of priority from U.S. Provisional Patent Application No. 61/508,828, filed Jul. 18, 2011, which is incorporated herein by reference in its entirety.

### BACKGROUND OF THE INVENTION

1. Field of the Invention

The present invention relates generally to navigational systems and methods, such as inertial based navigation systems, and in particular to a user navigation guidance and network system for use in connection with users navigating a particular location using inertial navigation techniques.

2. Description of the Related Art

Inertial navigation systems are used and applied in various situations and environments that require accurate navigation functionality without the necessary use of external references during the navigational process. For example, inertial navigation systems and methods are used in many indoor environments (wherein a Global Navigation Satellite System, such as the Global Positioning System, is unusable or ineffective), such as in connection with the navigational activities of a firefighter in a structure. However, in order to be effective, inertial navigation systems must initialize with estimate data, which may include data pertaining to the sensor position, velocity, orientation, biases, noise parameters, and other data. Further, such as in pedestrian navigation applications, where each inertial navigation module is attached to a user (e.g., the boot of a firefighter), a system must relate the relative position of multiple users to the same reference. In particular, this relationship provides knowledge for one user to locate another user in the absence of external knowledge or aids. Following initialization and/or turn-on, inertial navigation systems require ongoing analysis and correction to mitigate drift, bias, noise, and other external factors that affect the accuracy of these sensors and systems.

Position is a requirement of most navigation systems. In certain existing systems, sensors may provide information relating to position, thus allowing an algorithm to derive position. In other systems, the available sensors may not provide sufficient information to derive position, and therefore may require an initial position estimate from which the system propagates thereafter. A user, device, marker, or other external source may provide such an initial position estimate. It is also recognized that location systems that provide a graphical user path to a central controller, such as a commander's computing device, require accurate track shape and relative track positioning between firefighters to improve situational awareness for location management.

As discussed above, it is important to understand the position of users relative to other users and/or other reference points or features navigating or positioned at the location. This allows for all users and various reference points or features to be placed in a common (global) frame of reference for accurate tracking. Existing systems use this (and other) information to generate a virtual view of the location or scene at a central control point, such that the primary user, e.g., the commander at a fire scene, can understand where all of the assets are located and the layout of the scene. As is known, this facilitates helpful, and often critical, information to be communicated from the commander to the user, i.e., firefighters and other personnel located at the scene. This is normally accomplished through direct radio communication between the commander (or some central command unit) and each firefighter. However, these existing systems do not effectively allow the user to understand their position with respect to other users or other features on the scene. This represents a deficiency in the growing need for complete situational awareness at the user level. In addition, how this information is presented to the user during the navigational process (which is often during an emergency situation) is also important.

Communication between the central controller and each individual user, which is normally accomplished through radio communication, is not always available. During these “dark” situations, the firefighter is out of communication with the commander (or central controller) and the relative navigational process degrades. In addition, these existing systems do not take into account the usefulness of utilizing the local position of users with respect to each other, or with respect to known reference points.

Therefore, there remains a need in the art to provide inertial navigation systems and methods that makes better user of the navigational and other positioning data about the location to improve situational awareness, and to facilitate more reliable communication infrastructure. Such improvements ultimately lead to a safer navigational environment for all of the users.

### SUMMARY OF THE INVENTION

Generally, the present invention provides a user navigation guidance and network system that addresses or overcomes certain drawbacks and deficiencies existing in known navigation systems. Preferably, the present invention provides a user navigation guidance and network system that is useful in connection with navigation systems relying on inertial navigation techniques as the primary navigational component. Preferably, the present invention provides a user navigation guidance and network system that improves situational awareness, both at the control level and the user level. Preferably, the present invention provides a user navigation guidance and network system that analyzes and presents critical information to the users in an understandable and helpful manner. Preferably, the present invention provides a user navigation guidance and network system that provides a reliable communication infrastructure. Preferably, the present invention provides a user navigation guidance and network system that leads to enhanced safety procedures for users during the navigational process.

In one preferred and non-limiting embodiment, provided is a user navigation guidance system, including: at least one personal inertial navigation module associated with at least one user and comprising a plurality of sensors and at least one controller configured to generate navigation data; at least one central controller configured to: directly or indirectly receive at least a portion of the navigation data from the at least one personal inertial navigation module; and generate global scene data in a global reference frame for locating at least one of the following: the at least one user, at least one other user, at least one feature, at least one position, or any combination thereof; at least one personal navigation guidance unit having at least one controller and associated with the at least one user, wherein the at least one personal navigation guidance unit is configured to: directly or indirectly receive at least a portion of the global scene data from the at least one central controller; and generate guidance data associated with the at least one user, the at least one other user, the at least one feature, the at least one position, or any combination thereof; and at least one display device configured to generate and provide visual information to the at least one user.

In another preferred and non-limiting embodiment, provided is a user navigation network system, including: a plurality of personal inertial navigation modules, each associated with a respective user and comprising a plurality of sensors and at least one controller configured to generate navigation data; at least one communication device configured to transmit and/or receive data signals using at least one of the following: short-range wireless communication, long-range wireless communication, or any combination thereof; and at least one personal navigation guidance unit associated with at least one guidance user and in direct or indirect communication with the at least one communication device, wherein the unit comprises at least one controller configured to receive, transmit, process, and/or generate global scene data associated with the at least one guidance user, at least one other user, at least one feature, the at least one position, or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of one embodiment of a user navigation guidance and network system according to the principles of the present invention;

FIG. 2 is a schematic view of another embodiment of a user navigation guidance and network system according to the principles of the present invention;

FIG. 3(a) is a schematic view of a further embodiment of a user navigation guidance and network system according to the principles of the present invention;

FIG. 3(b) is a schematic view of a still further embodiment of a user navigation guidance and network system according to the principles of the present invention;

FIG. 4 is a schematic view of another embodiment of a user navigation guidance and network system according to the principles of the present invention;

FIG. 5 is a schematic view of a further embodiment of a user navigation guidance and network system according to the principles of the present invention;

FIG. 6 is a screen view of one embodiment of a display in a user navigation guidance and network system according to the principles of the present invention;

FIG. 7 is a schematic view of a further embodiment of a user navigation guidance and network system according to the principles of the present invention;

FIG. 8 is a schematic view of another embodiment of a user navigation guidance and network system according to the principles of the present invention; and

FIG. 9 is a schematic view of a still further embodiment of a user navigation guidance and network system according to the principles of the present invention.

### DETAILED DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention relates to a user navigation guidance and network system 10 and associated methods, with particular use in the fields of navigation, location tracking, and scene management. In particular, the system 10 and method of the present invention improves situational awareness, both at the control level and the user level, and provides critical information to the users in an organized and helpful visual manner. In addition, the system 10 and method of the present invention facilitates the establishment of a reliable communication infrastructure, and leads to enhanced safety procedures for users during the navigational process. Still further, the presently-invented system 10 and method can be used in connection with a variety of applications and environments, including, but not limited to, outdoor navigation, indoor navigation, tracking systems, resource management systems, emergency environments, fire fighting events, emergency response events, warfare, and other areas and applications that are enhanced through effective feature tracking and mapping/modeling.

In addition, it is to be understood that the system 10 and associate method can be implemented in a variety of computer-facilitated or computer-enhanced architectures and systems. Accordingly, as used hereinafter, a “controller,” a “central controller,” and the like refer to any appropriate computing device that enables data receipt, processing, and/or transmittal. In addition, it is envisioned that any of the computing devices or controllers discussed hereinafter include the appropriate firmware and/or software to implement the present invention, thus making these devices specially-programmed units and apparatus. Further, as used hereinafter, a “communication device” and the like refer to any appropriate device or mechanism for transfer, transmittal, and/or receipt of data, regardless of format. Still further, the communication may occur in a wireless (e.g., short-range radio, long-range radio, Bluetooth®, and the like) or hard-wired format, and provide for direct or indirect communication.

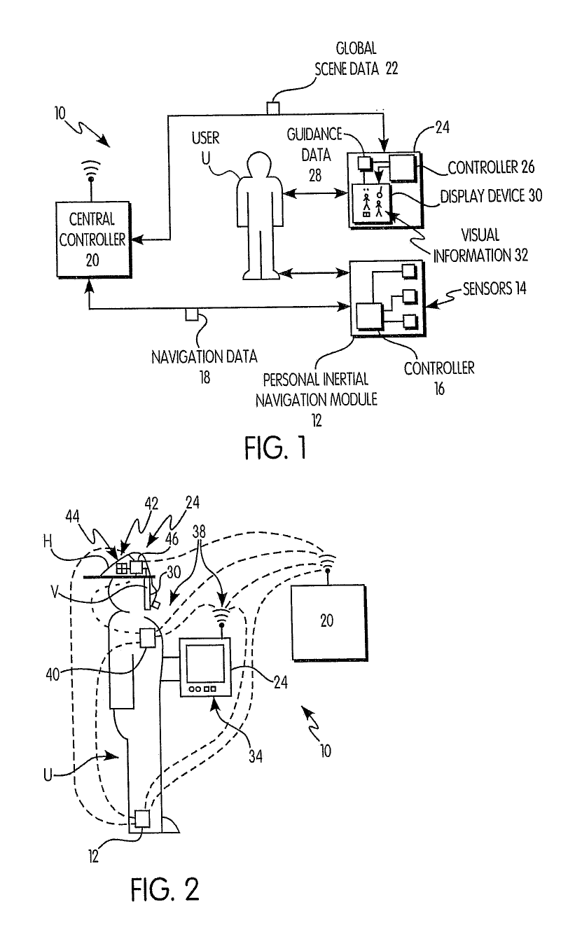

As illustrated in schematic form in FIG. 1, and in one preferred and non-limiting embodiment, the user navigation guidance and network system 10 of the present invention includes at least one personal inertial navigation module 12, which is associated with a user U. This personal inertial navigation module 12 includes multiple sensors 14, and at least one controller 16 configured or programmed to obtain data from the sensors 14 and generate navigation data 18. As is known, these sensors 14 may include one or more accelerometers, gyroscopes, magnetometers, and the like. In addition, these sensors 14 may sense and generate data along multiple axes, such as through using an accelerometer triad, a gyroscope triad, and a magnetometer triad. The controller 16 obtains raw, pre-processed, and/or processed data from the sensors 14, and uses this data to generate navigation data 18 specific to the user U in the user's U navigation frame of reference.

While the personal inertial navigation module 12 may be attached or associated with a user U in any known location on the body of the user U, one preferred and non-limiting embodiment provides for some attachment arrangement or mechanism for removably attaching the module 12 to the user's U boot. Attachment to the user's foot or foot area is well known in the art of personal inertial navigation, primarily based upon the stationary position of the foot during the stride, whether walking, running, crawling, etc.

In this preferred and non-limiting embodiment, the system 10 further includes at least one central controller 20, which is operable to directly or indirectly receive some or all of the navigation data 18 from the personal inertial navigation module 12. In this embodiment, and based at least partially upon some or all of the navigation data 18 of the user U, the central controller 20 generates global scene data 22 in a global reference frame. This global reference frame refers to a navigation frame of reference that is common to one or more users, features, positions, and the like. Further, navigation in this global frame of reference is necessary in order to track multiple discrete persons, items, features, and other objects with respect to each other. Accordingly, when used with multiple users U, features, or other objects with positions, the central controller 20 facilitates appropriate data processing and management in order to “place” personnel, features, objects, items, and the like on a common map or model. Therefore, this global scene data 22 includes or is used to locate the user U, one or more other users U, one or more features, one or more positions, and the like.

As further illustrated in FIG. 1, the system 10 includes at least one personal navigation guidance unit 24 associated with one or more of the users U. This unit 24 includes a controller 26, and is capable of directly or indirectly receiving at least a portion of the global scene data 22 from the central controller 20. In addition, this unit 24, and specifically the controller 26, is configured or programmed to generate guidance data 28 that is associate with the user U, one or more other users U, one or more features, one or more positions, and the like.

Still further, the system 10 includes a display device 30 that is capable of generating and providing visual information 32 to the user U. This visual information 32 may include some or all of the guidance data 28, some or all of the global scene data 22, some or all of the navigation data 18, or any other information or data that is useful for navigating in the global frame of reference.

Accordingly, the system 10 of the present invention virtualizes the data gathered by the personal inertial navigation modules 12 for use in generating the global scene data 22, the guidance data 28, and/or the visual information 32. Any of this data can then be provided directly or indirectly to the personal navigation unit 24 to provide the above-mentioned situational awareness at specified scenes and target environments. For example, and as discussed hereinafter, the user U may be a responder or firefighter operating in an emergency scenario, and the system 10 of the present invention provides this beneficial and useful visual information 32 to the user U on the display device 30 in a variety of forms and formats, as discussed hereinafter.

In another preferred and non-limiting embodiment, and as illustrated in FIG. 2, the navigation guidance unit 24 is in the form of a portable unit 34, such as a hand-held device, e.g., a portable computer, a Personal Digital Assistant (PDA), a cellular phone, or some other mobile computing device. In addition, the display device 30 can be a screen, a display, a visual indicator, a light, a light-emitting diode, or any other device or mechanism that provides visual information to the user U based at least partially on the navigation data 18, global scene data 22, and/or the guidance data 28.

In another preferred and non-limiting embodiment, the navigation guidance unit 24 is associated with, connected to, in electronic communication with, or otherwise integrated with a helmet H of the user U. Further, in this embodiment, the display device 30 may be a screen or display provided on a portion of the helmet H, or some other visual indicator, light, light-emitting diode, or the like that is within the user's U view. In addition, the display device 30 may project or otherwise generate and place this visual information 32 on an inner portion of a face shield or other equipment attached to or associated with the user's helmet H, such that this visual information 32 is immediately and dynamically displayed to the user U during the navigational process.

As further illustrated in FIG. 2, the system 10 may include one or more communication devices 38, which are used to transmit, receive, and/or process data within the system 10. One preferred and non-limiting arrangement uses a centrally-positioned radio 40, which is capable of short-range and/or long-range communications. For example, in this embodiment, the radio 40 is able to send and receive data to and from the personal inertial navigation module 12, the navigation guidance unit 24, and/or the central controller 20. Similarly, the radio 40 is capable of establishing a communication link with other specified equipment worn or used by the user U. However, it is also envisioned that the communication device 38 is associated with, part of, or integrated with the navigation guidance unit 24, e.g., positioned in the same housing. However, as discussed above, whether using long-range or short-range (e.g., Bluetooth) communications, any of the personal inertial navigation modules 12, central controller 20, navigation guidance units 24, radio 40, or any other communication device 38 can be utilized to transmit, process, and/or receive data. While one preferred embodiment centralizes communications between the radio 40 associated with or attached to the user U, other communication architectures and setups can be used to transmit, process, and/or receive data generated by or used in connection with the presently-invented system 10.

With continued reference to FIG. 2, the navigation guidance unit 24 may also include or be in communication with an orientation module 42 including one or more sensors 44 and a controller 46. In particular, the controller 46 obtains sensed data, raw data, pre-processed data, and/or processed data from the sensors 44 and generates orientation data that indicates the orientation of the navigation guidance unit 24. This orientation module 42 is especially useful in connection with a navigation guidance unit 24 that is mounted on or integrated with a helmet H worn by the user U. In one implementation, and when using such a helmet-based navigation guidance unit 24, the unit 24 knows the user's U location or position in the global frame of reference based upon the navigation data 18, either communicated directly or indirectly from the personal inertial navigation module 12 and/or the central controller 20. Further, this information can be provided to the navigation guidance unit 24 as part of the global scene data 22 and/or the guidance data 28. The orientation data associated with the helmet H may include orientation or other information with respect to magnetic north. From the position of the firefighter to the destination, a travel vector can be created and transmitted from the central controller 20 as part of the global scene data 22 for facilitating the creation of guidance data 28.

Accordingly, while the navigation guidance unit 24 can obtain the location of the user U, it can use this orientation module 42 to understand the orientation of the user's U head, which is often different than the orientation of the user's U boot or foot. This orientation module 42, and specifically the controller 46 of the module 42, can either determine the orientation of the user's U head in the user-specific local frame of reference with respect to the user's U boot orientation, or in the global frame of reference through direct or indirect communication with the central controller 20. Accordingly, in one preferred and non-limiting embodiment, the direction of the user's U body or boot can be determined either locally or in the global frame of reference, and the orientation of the user's U head (or helmet H) can be determined from the use of known sensors 44, such as a tri-axial accelerometer, a tri-axial magnetometer, a tri-axial gyroscope, and the like.

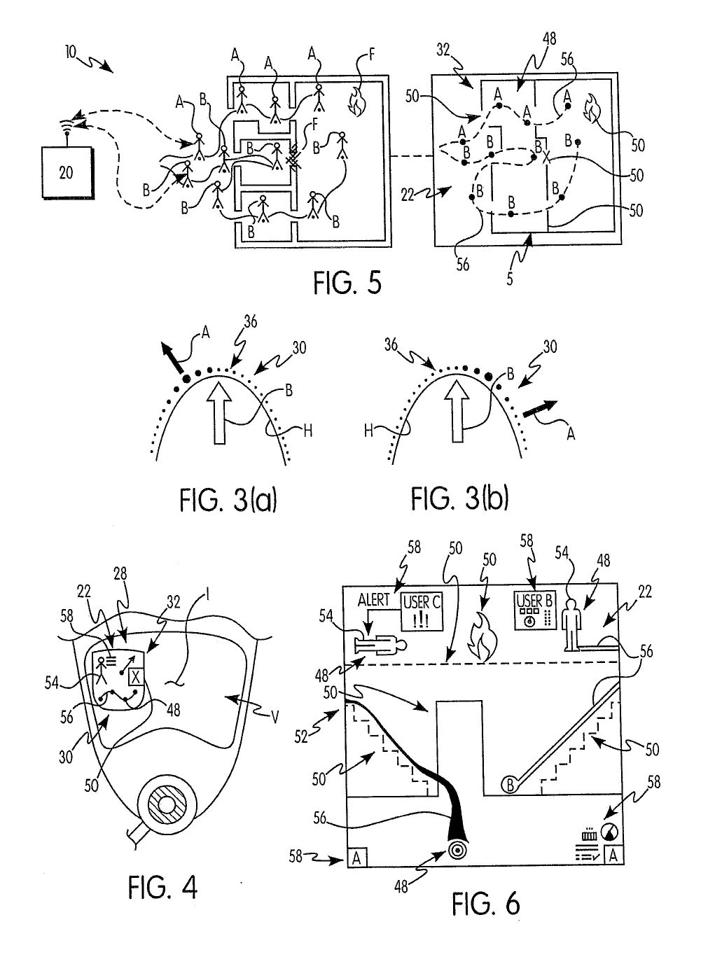

As illustrated in FIGS. 3(a) and 3(b), and in one preferred and non-limiting embodiment, included is a continuous screen and/or array of discrete light-emitting diodes (LEDs) 36, which provide the visual information 32 to the user U. As seen in FIGS. 3(a) and 3(b), the intensity of the LEDs 36 provides guidance data 28 to the user U in the form of a guidance direction (Arrow A) with respect to the direction (Arrow B) that the user's U head is facing. Accordingly, the user U can use these LEDs 36 to bring the most intense portion of the screen or these LEDs 36 directly in line with the direction that they are facing, and then move in that direction to locate another user U, a feature F, a position, and the like.

In another preferred and non-limiting embodiment, and as illustrated m FIG. 4, at least a portion of this visual information 32 (e.g., navigation data 18, global scene data 22, and/or guidance data 28) is generated, used to generate, or provided on an inner surface I of a visor V of the helmet H of the user U. This visual information 32 can be projected onto the inner surface I, or maybe overlaid on at least a portion of this inner surface L Therefore, this important visual information 32 remains in the user's U line-of-sight, but is preferably not placed in an area that obstructs or otherwise obscures the user's U view of the environment and surroundings.

In this embodiment, the navigation data 18 is transmitted to the central controller 20 (e.g., base station, remote unit, centralized command control, etc.) and stored and processed. This processed data can then be transmitted back to each user U (or a selection of users U) as global scene data 22. Each of the user's U navigation guidance units 24 receive the global scene data 22 and generate consistent and accurate guidance data 28, which may include, without limitation, navigation data 18, global scene data 22, visual information 32, user position data 48, feature data 50, data for generating a virtual scene 52, data for generating avatars 54, data for generating paths 56, user data 58, or the like. As discussed, all users U, features F, and/or positions are placed in the global frame of reference, i.e., a normalized coordinate system. The user's U frustum (or line-of-sight) is determined by using the above-discussed orientation module 42, which is in communication or integrated with the helmet-mounted navigation guidance unit 24 of each user (or specified users). The virtual scene 52 is then generated, rendered and/or displayed to the user U on the inner surface I of the visor V (or lens) in a first-person point-of-view.

In this preferred and non-limiting embodiment, this visual information 32 includes direction or location data that will assist in guiding the user U to another user U, some feature F, or some other location or position within the global frame of reference. In addition, this visual information 32 may also provide user data 58, feature data 50, position data, or other useful information that is specifically associated with known users U, features F, positions, objects, items, markers, and the like positioned or located in the global frame of reference. As discussed and illustrated hereinafter, the visual information 32 can be generated and displayed in a variety of forms and formats that facilitate the easy and quick understanding of this dynamic data.

In another preferred and non-limiting embodiment, and as illustrated in FIG. 5, the presently-invented system 10 is used in connection with user A and user B navigating in a building or similar structure S. Both user A and user B are using the above-described personal inertial navigation module 12, as well as a navigation guidance unit 24, and as such, are in direct or indirect communication with the central controller 20. The central controller 20 provides global scene data 22 to both user A and user B (such as through a communication link with the navigation guidance unit 24, a communication link with the user's A, B radio 40, etc.) for use in navigating in the target environment, e.g., the building, structure S, or environment.

With continued reference to FIG. 5, the navigation data 18 of each user A, B is used by the central controller 20 to generate global scene data 22 in the global reference frame, which comprises or is used to generate guidance data 28, which is then partially or wholly embodied as part of the visual information 32 for display on the display device 30. For example, this visual information 32 includes user position data 48 for each user A, B (including waypoints, past positions, or the path 56) and feature data 50, such as building walls, objects in the environment, items in the environment, safety events (e.g., blockages, fire points, etc.), or any other feature F that can be visually provided to the user A, B during the navigational process. Therefore, each user A, B is provided with visual information 32 and associated data that increases situational awareness and improves safety during the event.

In a still further preferred and non-limiting embodiment, and as illustrated in FIG. 6, the visual information 32 is generated or projected on a surface (e.g., an inner surface I of the user's U visor V) that is within the user's line-of-sight, specifically the line-of-sight of user A, such as in the embodiment of FIG. 4. As discussed, as user A reorients his head, the virtual scene 52 is generated or provided. This virtual scene 52 includes user position data 48, which includes an avatar 54 of each other user B, C in the virtual line-of-sight (or general directional area) of user A, as well as the path 56 of all users A, B, C. These paths 56 can be sized, shaped, colored, or otherwise configured to provide user A with accurate and easily-understandable information. As seen in FIG. 6, the path 56 of user A is dark, while the path of user B is light. Also, the avatars 54 of each user A, B, C can be modified to indicate various states or situations, e.g., user C is in alert mode and has been incapacitated. In order to get to user C (or instruct user B how to get to user C (since they are closer)), the virtual scene 52 generates or otherwise provides specific features F, such as doors, steps, floors, situations, events, blockages, conditions, and the like. Still further, user data 58 is presented to user A, which provides user A with data about other users B, C in the virtual scene 52, or about himself (i.e., user A).

In this embodiment, the paths 56 of other users U (or responders) are normalized by and through the central controller 20 and associated network in order to reconcile mismatches or other errors introduced by the use of multiple personal inertial navigation modules 12. The orientation module 42 is attached to or integrated with the responder's helmet H, and relays its orientation data to the radio 40. Inside the user's mask (in particular, the visor V), the virtual scene 52 is provided in front of the user's U eyes, where the paths 56 are displayed as ribbon lines of varying width, the positions or locations of other users U (as an avatar 54) are displayed, and user data 58 is provided as a “billboard” next to the appropriate user U. It is, of course, envisioned that the virtual scene 52 (or any of the visual information 32) can be display in a two-dimensional or three-dimensional format. Further, this visual information 32 is overlaid on or within the user's U viewing area, thereby immersing the user U into the digital data of the virtual scene 52. Still further, in this embodiment, the user U can view all other user's U position or location, status, and paths 56, regardless of visual obstructions, such as smoke or solid walls. In this embodiment, the user U is also capable of viewing, or having displayed, any information or data regarding users U, features F, positions, etc. that is created or originates from any point in the system 10.

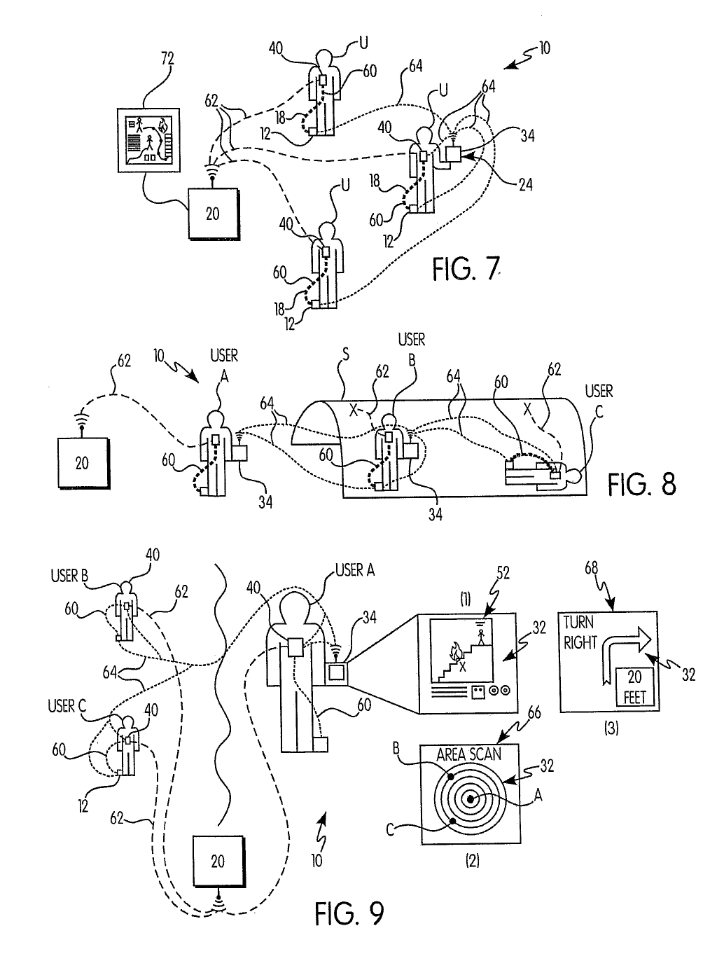

In another preferred and non-limiting embodiment, and as illustrated in FIG. 7, the personal inertial navigation module 12 of each user U wirelessly transmits the navigation data 18 to the radio 40 using short-range wireless technology. The radio 40 acts as a repeater, and forwards the navigation data 18 to the central controller 20 using long-range (e.g., 900 MHz) radio signals. In this embodiment, the central controller includes or is in communication with a central display device 70, which provides information to the commander or other high-level user. Accordingly, some or all of the navigation data 18, the global scene data 22, the guidance data 28, the visual information 32, or any data stream or associated information generated within the environment can be displayed on this central display device 70, and configured using a command interface of the central controller 20. As further illustrated in FIG. 7, at least one user U is equipped with or is otherwise in possession of the personal navigation guide unit 24, which includes a radio receiver or transceiver of the same personal area network (PAN) technology as is used in the personal inertial navigation module 12. While the PAN link between each user's U inertial navigation module 12 and radio 40 is addressed only by and between these specific units, the navigation guidance unit 24 is configured to “listen” to all traffic that is within its radio frequency range, including the user's U own wireless communications. It is further noted that there may or may not be an established link between the inertial navigation module 12 and the navigation guidance unit 24, and instead, the navigation guidance unit 24 is simply decoding the available radio frequency signals that are exchanged between each inertial navigation module 12 and its associated radio 40. Accordingly, FIG. 7 illustrates the use of a short-range link 60 between each user's U inertial navigation module 12 and radio 40, and a long-range link 62 between each user's U radio 40 and the central controller 20. Further, the navigation guidance unit 24 intercepts or “reads” short-range signals 64 in a specified proximity, such as the signals (and associated data) emitted by the inertial navigation module 12. While, in this preferred embodiment, the navigation guidance unit 24 intercepts or “reads” the local short-range signals, it can also be configured to receive, process, and/or transmit the long-range signals transmitted over the various long-range links 62 of the users U.

In another preferred and non-limiting embodiment, the short-range link 60 between the inertial navigation module 12 and the radio 40 uses Bluetooth® technology, which, in some instances, may provide some hindrances to the “listening” function of the navigation guidance unit 24. Accordingly, in this embodiment, a link or connection between the navigation guidance unit 24 and each inertial navigation module 12 can be established. When using Bluetooth® communications as the architecture for the short-range link 60, the radio 40 may also be equipped with or configured as an IEEE 802.15.4 radio, which is normally used to communicate with other equipment, e.g., other communication-enabled firefighting equipment. IEEE 802.15.4 radio signals are easier to receive promiscuously, and a link establishment is not required. Accordingly, the radio 40 could automatically repeat navigation data 18 (or other data) received from the inertial navigation module 12 via Bluetooth® communication by re-transmitting it on an IEEE 802.15.4 link. Therefore, the navigation guidance unit 24 would also be equipped to be able to receive this information.

The system 10 of the present invention is useful in connection with a variety of navigation and safety-related activities. For example, FIG. 8 illustrates a situation where user A and user B are each equipped with the navigation guidance unit 24. Further, user B and user C are both within a structure S that prevents communication by or establishing a link between the user's radio 40 and the central controller 20. Such a situation may occur when the structure S is a tunnel, which inhibits or prevents effective radio frequency communication.

As seen in FIG. 8, user C has become incapacitated or disabled and must be located for rescue. In one embodiment, one or both of the rescuers, i.e., users A or B, can be directed to the last known location or position of the victim (user C), e.g., at the entrance to the structure S. From there, the navigation guidance unit 24 of user B scans radio frequencies for inertial navigation module 12 short-range signals 64. If such signals 64 are received, the relative location and distance of the victim (user C) to the rescuer (user A or user B) can be calculated by capturing the location information, e.g., navigation data 18, transmitted from the rescuer user A or B and the victim (user C) through the calculation of a vector between the users U. Even if user B, himself, loses contact with the central controller 20, as long as user C is within range of user B, the navigation guidance unit 24 will be capable of guiding user B using navigation data 18, global scene data 22, and/or guidance data 28. Still further, if user B does maintain long-range radio communications (e.g., the long-range link 62) with the central controller 20, it is one option for the rescuer (user B) to forward the victim's (user C′s) location to either user A or the central controller 20, and thus, become an ad-hoc repeater for user C. Still further, the navigation data 18 of both user C and user B can be read by or transmitted to the navigation guidance unit 24 of user A, who does have a long-range link 62 with the central controller 20. Therefore, any type of “repeater” set up and configuration can be used by and between multiple users U. In a further embodiment, if the victim (user C) has lost his or her long-range link 62 with the central controller 20, it is likely that they also lost voice radio communications. Accordingly, if user A or B is within radio frequency range of user C, and is now aware of the location of user C, using the navigation guidance unit 24, instead of putting himself at risk in entering the structure S (where they may also then lose the long-range link 62), he or she may choose to establish voice radio communications with the victim (user C) to help guide them to a safe location.

Accordingly, and in an emergency situation where multiple users U are navigating in an environment, the use of the presently-invented system 10 and navigation guidance unit 24 will assist the user U in becoming more aware of his or her location or position relative to other users U, features F, or positions in the scene. For example, often firefighters are not aware of others that are nearby, because of limited visibility due to smoke or other obstructions. For example, other users U may be nearby, but on the other side of a wall. However, the system 10 of the present invention provides a navigation guidance unit 24 that can harvest the short-range signals 64 (or, if applicable, long-range signals) from these other nearby users U, and display the relative location and distance of the user U to the other location-system users U navigating in the scene. This provides an advantage in a “self-rescue” situation, but is even more useful in a non-emergency situation.

As discussed above, and when tracking multiple users U, features F, or positions, a common coordinate frame is required, i.e., a global reference frame. As is known, the navigation data 18 generated or transmitted by the inertial navigation module 12 must be transformed or translated into this common coordinate system. Therefore, if adjustments to the inertial navigation module 12 occur upstream, the navigation guidance unit 24 will require additional global scene data 22 (and/or navigation data 18) to reestablish relative location and position information.

As discussed above, when the navigation guidance unit 24 is attached to and/or integrated with a helmet H, the orientation module 42 is used to ensure that proper global scene data 22 and/or guidance data 28 is generated. It is further envisioned that such an orientation module 42 can be used in connection with a handheld navigation guidance unit 24, i.e., the above-discussed portable unit 34, in order to ensure that proper navigation data 18, global scene data 22, and/or guidance data 28 is generated. For example, this orientation module 42 can be used to detect angular changes in position, or alternatively, the navigation guidance unit 24 may somehow be rigidly mounted in connection with the user U to provide a rigid correlation. In addition, the user U may be trained to hold and use the navigation guidance unit 24 in a certain manner to ensure this accuracy. Still further, the navigation guidance unit 24 may be attached to or integrated with another piece of equipment worn or used by the user U, such as the above-discussed helmet H. For example, in a firefighter setting, the navigation guidance unit 24 may be attached to or otherwise integrated with a self-contained breathing apparatus, such that the position of the navigation guidance unit 24 relative to the body of the user t is substantially unchanged.

The navigation guidance unit 24 takes advantage of the short-range signals 64 being carried over the radio frequency channels. Therefore, one unique function is the ability of the navigation guidance unit 24 to promiscuously intercept all available network traffic that is transmitted over the various PAN networks. Accordingly, and in this manner, by capturing the location of the user U of the navigation guidance unit 24, along with those of other users U in the nearby area, the user U of the navigation guidance unit 24 can be presented with visual information 32 that indicates the user's U location in relation to other nearby personnel, without the need for interaction with the central controller 20 (and without using the long-range radio network). However, as also discussed above, in other preferred and non-limiting embodiments, the navigation guidance unit 24 can be provided with direct or indirect communication with the central controller 20 (e.g., a base station) through a short-range link 60 and/or a long-range link 62. This permits the navigation guidance unit 24 to obtain additional relevant information in the form of the global scene data 22, such as the user's U movement history (path 56) and any identifying landmarks or features F, such as walls, stairs, doors, etc. As discussed, the visual information 32 can be presented in a manner that helps direct the user U to a victim, or to help direct the user U to a specific location or position in a self-rescue effort. For example, the guidance data 28 may include or be used to generate directional information to be provided to the user U showing a constantly-updating direction indicator. The system 10 and navigation guidance unit 24 provides both a visual indication of the user's U location, as well as other users U and/or features F in the area. Therefore, the maintenance of radio contact to help locate and rescue a victim is not required.

In one preferred and non-limiting embodiment, the navigation guidance unit 24 is configured to receive short-range signals 64 from only a certain set of or location of inertial navigation modules 12. However, if the navigation guidance unit 24 can establish a link to the central controller 20 through the user's U radio 40, the navigation guidance unit 24 can exchange additional information data with the central controller 20. Establishing such a long-range link 62 enables the user U to receive visual information 32 on the navigation guidance unit 24, which is invaluable in many situations, such as rescue situations, or even while carrying out standard, non-emergency tasks. Putting this visual information 32 in the hands of the user U actually navigating the scene is extremely beneficial.

FIG. 9 illustrates a further preferred and non-limiting embodiment of the present invention, including alternate presentations of visual information 32 on the display device 30 of the navigation guidance unit 24. In particular, and as illustrated in view (1) of FIG. 9, the visual information 32 provided to the user U of the navigation guidance unit 24 (i.e., on the display device 30 of the navigation guidance unit 24) is at least partially in the form of the virtual scene 52. This virtual scene 52 includes one or more avatars 54, paths 56, and user data 58 (as discussed above).

As illustrated in view (2), the visual information 32 can be provided in the form of a radar display 66, which illustrates the position of user B and user C with respect to user A (who is equipped with a navigation guidance unit 24). User A can utilize this radar display 66 to obtain the relative position and distance of others nearby, who, for example, may be in a different room and are possibly not visible or in audio range.

With continued reference to FIG. 9, and view (3), the visual information 32 can include a directional display 68, which provides specific guidance data 28 for guiding the user U to a specific position, user U, feature F, or other location at the scene. For example, view (3) illustrates the directional display 68 including directional arrows, textual directions, and distances. Accordingly, as opposed to duplicating the information provided on a display of the central controller 20, the visual information 32 (provided as a virtual scene 52, radar display 66, and/or directional display 68) is presented in a simplified form in order to allow the user U to concentrate on the task at hand. For example, and for a rescue operation, the user U of the navigation guidance unit 24 may receive the above-discussed directional display 68 instead of a map of the entire structure S or scene. In addition, the visual information 32 for any of these displays can be dynamically generated and/or updated in order to ensure accurate information is placed in the hands of the ultimate user U.

By integrating the above-discussed functionality with a thermal imaging camera, the navigation guidance unit 24 is further enhanced. During a search for firefighters or others in trouble, the combination of a thermal image capable of indicating a human body and the display of the relative location of the user U to a potential victim will result in a powerful search-and-rescue tool. In addition, when the victim is a user of a personal inertial navigation module 12, the rescue team's relative location indicator can speed up the search effort by helping to guide the searcher in the direction of the victim, and the thermal display will help pinpoint the exact location by showing the body profile.

Still further, the system 10 and navigation guidance unit 24 of the present invention is useful in a variety of applications and environments. As discussed, during a search-and-rescue effort, the use of the navigation guidance unit 24 can facilitate location by allowing rescuers to see the victim's location and distance relative to their position. This allows the rescue team more independence from the commander or fire ground management team, which is important when multiple critical situations exist. If the rescue team is guided to the general area of the victim (for example, to the correct floor, or quadrant), they can likely take over and conduct the “last-mile” search for the victim by the use of the navigation guidance unit 24, thereby freeing up the fire ground management officer to concentrate on other critical issues. As discussed, this functionality is enhanced even further if it is integrated with a thermal imaging camera or similar device.

In another preferred and non-limiting embodiment, the navigation guidance unit 24 is not directly in contact with fire ground management, thus making it an extremely useful search-and-rescue tool in the case where voice and radio communications cannot be established from the user U to fire ground management. In one scenario, a victim is lost in an area, where radio frequency signals cannot propagate, such as a tunnel. Accordingly, and as discussed above, if a rescue team is dispatched, the team can be directed to the point where radio communications are no longer reliable. From this point, the rescue team can use the visual information 32 of the navigation guidance unit 24 to help locate the victim, since the navigation guidance unit 24, in this embodiment, only communicates on the local radio frequency network. Similarly, if the victim is not disabled, but he or she is still out of radio communications with the central controller 20 or fire ground management, he may still be aware of other personnel around him through the use of the navigation guidance unit 24 capable of communicating with the inertial navigation module 12. This would still allow the user U to move in the direction of the other personnel, and attempt to make contact with them. Therefore, the system 10 and navigation guidance unit 24 of the present invention are useful in many cases and environments, such as in those cases when firefighters are reluctant to declare a “mayday” even though they are lost or otherwise in trouble. Being aware that others are nearby, and knowing their relative position, the user U and/or potential victim has the option of contacting others and asking for help.

The system 10 of the present invention provides increased situational awareness for users U navigating in the scene or environment. The provided visual information 32 of the navigation guidance unit 24 provides important information and data to facilitate and achieve this benefit. Accordingly, the system 10 avoids errors and issues involved with voice-aided navigation. It is further recognized that the navigation guidance unit 24 can be augmented with additional devices or functionality, such as sonar functionality, thermal sensing functionality, or the like, which provides additional guidance data 28 (and/or global scene data 22) for use within the context of the system 10. As discussed above, the orientation module 42, whether used in connection with the helmet H or a portable guidance unit 34, provides useful orientation data that may be bundled with or part of the navigation data 18 transmitted to the central controller 20. In one embodiment, the orientation module 42 includes a digital compass reading and output from a tri-axial accelerometer for generating orientation data of the head relative to the body. In one example, when a firefighter becomes in distress or needs direction, guidance can be provided through the navigation guidance unit 24, and the guidance data 28 can facilitate or direct the firefighter back through a path that the firefighter just created, to another firefighter in a structure, to a waypoint (i.e., a feature F) created by the firefighter or the incident commander, to a path created by another firefighter, or the like. In this manner, provided is a user navigation guidance and network system that enhances communication, navigation, identification, tracking, and other functions in a navigational environment.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent units that are within the spirit and scope of the appended claims. For example, it is to be understood that the present invention contemplates that, to the extent possible, one or more features of any embodiment can be combined with one or more features of any other embodiment.

The invention claimed is:

1. A user navigation guidance system, comprising:
at least one personal inertial navigation module associated with at least one user and comprising a plurality of sensors and at least one controller configured to generate navigation data;
at least one central controller configured to: directly or indirectly receive at least a portion of the navigation data from the at least one personal inertial navigation module; and generate global scene data in a global reference frame for locating at least one of the following: the at least one user, at least one other user, at least one feature, at least one position, or any combination thereof;
at least one navigation guidance unit having at least one controller and associated with the at least one user, wherein the at least one personal navigation guidance unit is configured to: directly or indirectly receive at least a portion of the global scene data from the at least one central controller; and generate guidance data associated with the at least one user, the at least one other user, the at least one feature, the at least one position, or any combination thereof; and
at least one display device configured to generate and provide visual information to the at least one user.

2. The user navigation guidance system of claim 1, wherein the at least one navigation guidance unit comprises a portable unit and the at least one display device comprises at least one of the following: at least one screen, at least one display, at least one visual indicator, at least one light, at least one light emitting diode, or any combination thereof.

3. The user navigation guidance system of claim 1, wherein the at least one navigation guidance unit is associated or integrated with at least one helmet of the at least one user and the at least one display device comprises at least one of the following: at least one screen, at least one display, at least one visual indicator, at least one light, at least one light emitting diode, or any combination thereof.

4. The user navigation guidance system of claim 3, wherein at least a portion of the visual information is provided on at least a portion of an inner surface of a visor of the at least one helmet.

5. The user navigation guidance system of claim 3, wherein at least a portion of the visual information is overlaid on at least a portion of an inner surface of a visor of the at least one helmet.

6. The user navigation guidance system of claim 1, wherein at least a portion of the visual information comprises direction data configured to assist in guiding the at least one user to the at least one other user, the at least one feature, the at least one position, or any combination thereof.

7. The user navigation guidance system of claim 1, wherein at least a portion of the visual information comprises at least one of the following: user data, feature data, position data, or any combination thereof.

8. The user navigation guidance system of claim 1, wherein the at least one navigation guidance unit comprises at least one orientation module having a plurality of sensors and configured to generate orientation data.

9. The user navigation system of claim 8, wherein the plurality of sensors comprises at least one of the following: at least one accelerometer, at least one gyroscope, at least one magnetometer, at least one compass, at least one navigational sensor, or any combination thereof.

10. The user navigation guidance system of claim 1, further comprising at least one communication device associated with the at least one user and configured to transmit and receive data to and from at least one of the following: the at least one inertial navigation module, the at least one central controller, the at least one navigation guidance unit, the at least one display device, at least one other inertial navigation module, at least one other navigation guidance unit, at least one other display device, at least one other communication device, or any combination thereof.

11. The user navigation guidance system of claim 10, wherein the communication device is configured to establish short range radio network for data exchange with at least one other communication device of at least one other user.

12. The user navigation system of claim 1, wherein the plurality of sensors comprises at least one of the following: at least one accelerometer, at least one gyroscope, at least one magnetometer, at least one navigational sensor, or any combination thereof.

13. A user navigation network system, comprising:
a plurality of personal inertial navigation modules, each associated with a respective user and comprising a plurality of sensors and at least one controller configured to generate navigation data;
at least one communication device configured to transmit and/or receive data signals using at least one of the following: short-range wireless communication, long-range wireless communication, or any combination thereof; and
at least one personal navigation guidance unit associated with at least one guidance user and in direct or indirect communication with the at least one communication device, wherein the unit comprises at least one controller configured to receive, transmit, process, and/or generate global scene data associated with the at least one guidance user, at least one other user, at least one feature, the at least one position, or any combination thereof.

14. The user navigation network system of claim 13, wherein the at least one personal navigation guidance unit further comprises at least one display device configured to generate and provide visual information to the at least one guidance user.

15. The user navigation network system of claim 13, further comprising at least one central controller configured to: directly or indirectly receive at least a portion of the navigation data of the personal inertial navigation modules; and generate global scene data in a global reference frame for locating at least one of the following: the at least one guidance user, at least one other user, at least one feature, the at least one position, or any combination thereof.

16. The user navigation network system of claim 13, wherein the at least one communication device is configured to wirelessly receive at least one of the following: navigation data associated with the at least one guidance user, navigation data associated with the at least one other user, global scene data associated with the at least one guidance user, global scene data associated with the at least one other user, global scene data associated with the at least one feature, the at least one position, or any combination thereof.

17. The user navigation network system of claim 13, wherein the at least one personal navigation guidance unit is further configured to generate guidance data associated with the at least one guidance user, the at least one other user, the at least one feature, the at least one position, or any combination thereof.

18. The user navigation network system of claim 13, wherein the at least one personal navigation guidance unit is further configured to receive and/or transmit user data of the at least one other user.

19. The user navigation network system of claim 18, wherein at least a portion of the user data comprises navigation data of the personal inertial navigation module.

20. The user navigation network system of claim 13, wherein the at least one navigation guidance unit is further configured to generate relative location data between at least one of the following: the at least one guidance user, the at least one other user, the at least one feature, the at least one position, or any combination thereof and at least one of the following: the at least one guidance user, the at least one other user, the at least one feature, the at least one position, or any combination thereof, based at least in part upon at least one of the following: navigation data associated with the at least one guidance user, navigation data associated with the at least one other user, global scene data associated with the at least one guidance user, global scene data associated with the at least one other user, global scene data associated with the at least one feature, the at least one position, or any combination thereof.
